(19) United States
(12) Patent Application Publication
(10) Pub. No.: US 2025/0030309 A1
(43) Pub. Date: Jan. 23, 2025

(54) ELECTRIC MOTOR

(71) Applicant: BorgWarner Inc., Auburn Hills, MI (US)

(72) Inventor: Silvio Koch, Kirchheimbolanden (DE)

(21) Appl. No.: 18/768,988

(22) Filed: Jul. 10, 2024

(30) Foreign Application Priority Data
Jul. 21, 2023 (DE) 10 2023 119 286.8

(51) Int. Cl. H02K 7/08; H02K 1/2786; H02K 7/00

(52) U.S. Cl. CPC H02K 7/083; H02K 1/2786; H02K 7/003

(57) ABSTRACT

Disclosed is an electric motor having a stator, a rotor surrounding the stator, a shaft connected to the rotor in a rotationally fixed manner, and a housing that surrounds the rotor and the stator. The shaft has a first end arranged in the housing and a second end projecting out of the housing. The rotor has a back iron ring and permanent magnets attached to the inside of the back iron ring. The rotor has a carrier via which the back iron ring is connected to the shaft and through which the shaft projects, and the carrier is attached to the shaft between the second end of the shaft and bearings. The bearings include a floating bearing and a fixed bearing.

### RELATED APPLICATIONS

This application claims priority to DE 10 2023 119 286.8, filed Jul. 21, 2023, the entire disclosure of which is hereby incorporated herein by reference.

### BACKGROUND

This disclosure relates to an electric motor having a stator, a rotor surrounding the stator, a shaft connected to the rotor and a housing in which a first end of the shaft is arranged and from which a second end of the shaft protrudes. An electric motor generally of this type is known from EP 3 091 637 B1.

External rotor motors with permanent magnets have mechanical advantages over internal rotor motors, particularly as the permanent magnets are pressed against the rotor by centrifugal forces during operation and their mounting can therefore be designed more simply.

Electric motors must be protected from environmental influences in many applications, for example, in vehicles. In such applications, external rotor motors in which a first end of the shaft is arranged in the housing are advantageous, as the housing then contains fewer points subjected to environmental influences, in particular moisture, which can penetrate and damage the electric motor.

In the electric motor known from EP 3 091 637 B1, the shaft is mounted in the housing opening. The shaft is therefore only supported by bearings over a relatively short length and can therefore tilt relatively easily.

### SUMMARY

This disclosure demonstrates a way of improving the bearing of the shaft of electric motors of the type mentioned above.

In an electric motor according to this disclosure, the rotor comprises a carrier via which a back iron is connected to the shaft and through which the shaft protrudes. The carrier is attached to the shaft between a first end of the shaft, which protrudes from the housing, and a floating bearing and a fixed bearing. The carrier thus enables the shaft to be mounted at two points that are a considerable distance apart, making it difficult for the shaft to tilt.

A floating bearing, which can move axially relative to the shaft, can compensate for manufacturing tolerances, while the fixed bearing can absorb axial forces and thus ensure a stable position of the shaft relative to the stator.

An advantageous refinement of this disclosure provides for the fixed bearing to be pressed against a stop by clamping segments. The clamping segments can be fixed by means of screws that protrude through them. The clamping segments can be separate components or can extend as radial protrusions from a ring that surrounds the shaft. Regardless of how the clamping segments are designed, the shaft can have a flange via which it is connected to the carrier, whereby the flange projects radially further outwards than an outer ring of the fixed bearing, and the flange has recesses through which the screws can be accessed during assembly. In this way, the fixed bearing can be axially fixed during assembly, although the shaft has a flange that projects further outwards than the outer ring of the fixed bearing and can only be accessed from one direction on the fixed bearing for assembly. The flange is therefore located in the housing between the housing opening and the fixed bearing.

The fixed bearing is preferably located between the flange and the floating bearing. In this way, the shaft can be made robust where it transmits torque from the rotor and can be extended into the housing with little material to allow a greater distance between the two bearings.

A further advantageous refinement of this disclosure provides that the floating bearing is arranged at the first end of the shaft and the floating bearing bears against an annular shoulder of the shaft on its side facing the fixed bearing, and the fixed bearing bears against a further annular shoulder of the shaft on its side facing the second end of the shaft. The diameter of the shaft therefore increases in at least two steps from the first end of the shaft. Preferably, the shaft has a section between the two bearings in which its diameter increases, for example, a conical section.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a sectional view of an electric motor;

FIG. 2 shows a detailed view of the electric motor in axial viewing direction with the housing part removed and without carrier;

FIG. 3 shows an oblique view of FIG. 2; and

FIG. 4 shows a detailed view according to FIG. 2 without shaft.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

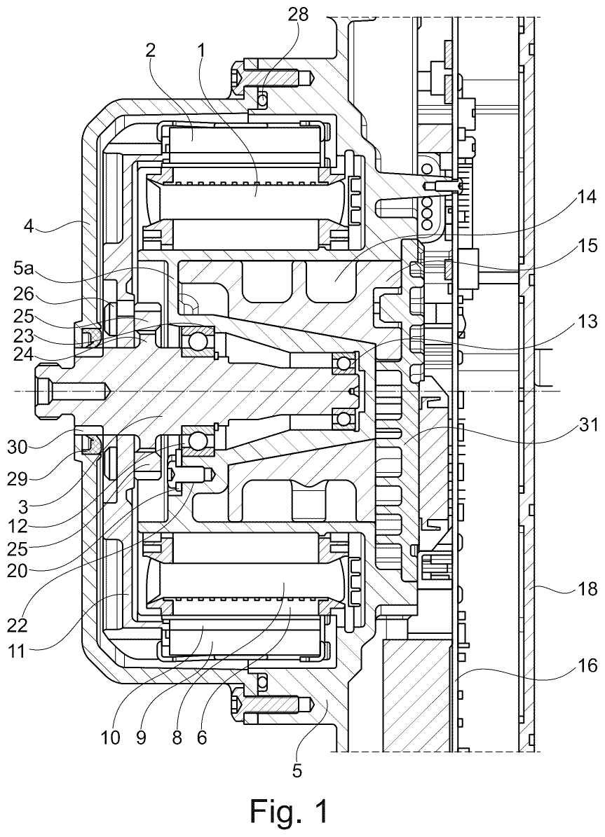

The electric motor shown in FIG. 1 comprises a stator 1, a rotor 2 surrounding the stator 1 and a shaft 3 connected to the rotor 2 in a rotationally fixed manner, i.e., rigidly. Stator 1 and rotor 2 are surrounded by a sealed housing, which has a first housing part 4, which forms a closed base on which the stator 1 rests, and a second housing part 5 as a cover, from which the shaft 3 protrudes. A first end of the shaft 3 is thus arranged in the housing and a second end of the shaft 3 is arranged outside the housing. The shaft 3 is mounted in a fixed bearing 12 and a floating bearing 13. The bearings can be designed as roller bearings, for example, ball bearings.

The stator 1 comprises a stack of laminated sheets 6 and stator windings 8. The rotor 2 comprises a back iron ring 9, to the inside of which permanent magnets 10 are attached, and a carrier 11, via which the back iron ring 9 is connected to the shaft 3 and through which the shaft 3 protrudes. The carrier 11 is attached to a flange 24 of the shaft 3 between the end of the shaft 3, which projects out of the housing, and the bearings 12, 13. In other words, the flange 24 is arranged between the second end of the shaft 3, which is located outside the housing, and the two bearings 12, 13.

The first housing part 5 has an inner part 5a, which projects into the stator 1 and surrounds the two bearings 12, 13 in the circumferential direction. This inner part 5a can be hollow and contain a channel 14 for cooling water. For example, an insert 15 can be arranged in the hollow inner part 5a of the housing part 5, which together with the inner part 5a of the housing part 5 defines a channel 14. The insert 15 is covered by a cooling plate 31 which is attached to the first housing part 5, for example, by welding, and thus fixes the insert 15 relative to the housing part 5. On its side facing away from the shaft 3, the first housing part 5 can carry control electronics with a printed circuit board 16 for supplying power to the stator windings 8, which is covered by a lid 18 attached to the first housing part 5, for example, in the form of a plate.

In the embodiment shown, a further cooling channel section is formed between the cooling plate 31 and the insert 15, which contributes to the cooling of the control electronics. High-powered components of the control electronics can be arranged on the side of the printed circuit board facing the cooling plate 31 and, in particular, rest against the cooling plate 31. For example, the cooling plate 31 can have protrusions, e.g., ribs or pins, on its side facing away from the control electronics, which project into the further cooling channel section and improve the thermal coupling of the cooling plate 31 to cooling liquid in the further cooling channel section.

In the embodiment shown, the fixed bearing 12 is arranged between the floating bearing 13 and the flange 24 of the shaft 3, with which the carrier 11 is attached to the shaft 3. The floating bearing 13 is arranged at the first end of the shaft 3, i.e., at the end that lies in the housing. As FIG. 1 shows, the shaft 3 forms a stop for an inner ring of the floating bearing 13, for example, in the form of an annular shoulder. The floating bearing 13 can be pressed against this stop by a spring ring that is supported on the housing part 5.

The fixed bearing 12 is pressed against a stop 23 by clamping segments 20, for example, three or more clamping segments 20, through which screws 22 protrude. The stop 23 is immovable relative to the stator 1 and is formed, for example, by the first housing part 5, in particular by its inner part 5a. The clamping segments 20 can be designed as separate components or as radially outwardly projecting protrusions that extend from a ring that surrounds the shaft 3. Such a ring can be integrated into an outer ring of the fixed bearing 12 or be designed as a separate ring that rests against the fixed bearing 12.

As shown in particular in FIG. 3, the clamping segments 20 each lie in a groove, which in the embodiment shown is formed in the inner part 5a of the housing part 5. The flange 24 of the shaft 3 can therefore rotate over the clamping segments 20 and the screws 22 that fix these clamping segments 20.

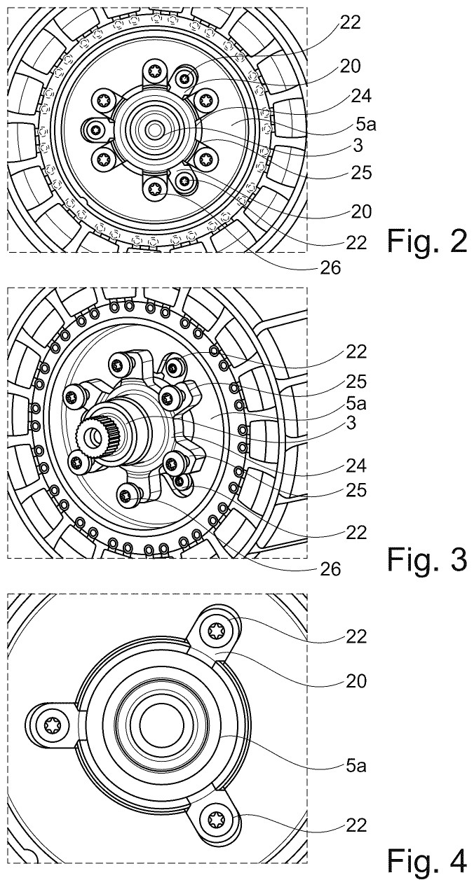

As already mentioned, the shaft 3 has a flange 24, via which it is connected to the carrier 11, for example, by means of screws 26. It is evident that the flange 24 projects radially further outwards than an outer ring of the fixed bearing 12 and the clamping segments 20, with which the fixed bearing 12 is pressed against its stop 23. As FIGS. 2 and 3 show, the flange 24 has recesses through which the screws 22 can be acted upon during assembly, with which the clamping segments 20 are fixed, pressing the fixed bearing 12 against its stop 23. These recesses, through which the screws 22 can accessed during assembly, are formed as free spaces between radially outwardly projecting protrusions 25 of the flange 24. The flange 24 can be screwed to the carrier 11 via these protrusions 25.

As FIG. 1 shows, the shaft 3 thickens between the floating bearing 13 and the fixed bearing 12. The diameter of the shaft 3 increases in several steps from its first end, which is located in the housing, to the flange 24. A first increase in the diameter results from the stop that the shaft 3 forms for the floating bearing 13. A further gradual increase in the diameter of the shaft 3 occurs at the fixed bearing, for which the shaft also forms a stop. The diameter of the shaft 3 can also increase between the floating bearing 13 and the locating bearing 12, for example, in a conical section.

The two housing parts 4, 5 can be screwed together and a seal 28 can be pressed between them. The shaft 3 is held in a bushing 30 in the opening of the housing through which it protrudes and the opening is sealed with a shaft seal 29.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### List of Reference Symbols

1 Stator

2 Rotor

3 Shaft

4 Housing part

5 Housing part

5a Internal part

6 Sheet stack

8 Stator windings

9 Back iron ring

10 Permanent magnets

11 Carrier

12 Fixed bearing

13 Floating bearing

14 Channel

15 Insert

16 Printed circuit board

18 Lid

20 Clamping segments

22 Screws

23 Stop

24 Flange

25 Protrusions

26 Screws

28 Seal

29 Shaft seal

30 Bushing

31 Cooling plate

What is claimed is:

1. An electric motor, comprising:
a stator;
a rotor surrounding the stator;
a shaft connected to the rotor in a rotationally fixed manner; and
a housing that surrounds the rotor and the stator;
wherein the shaft has a first end arranged in the housing and a second end projecting out of the housing;
wherein the rotor comprises a back iron ring and permanent magnets attached to the inside of the back iron ring;
wherein the rotor has a carrier via which the back iron ring is connected to the shaft and through which the shaft projects; and
the carrier is attached to the shaft between the second end of the shaft and bearings, said bearings comprising a floating bearing and a fixed bearing.

2. The electric motor according to claim 1, wherein clamping segments together with screws projecting through them press the fixed bearing against a stop, the shaft having a flange via which it is connected to the carrier, the flange projecting radially further outwards than an outer ring of the fixed bearing, and the flange having recesses through which the screws can be acted upon during assembly.

3. The electric motor according to claim 2, wherein the clamping segments comprise radial protrusions extending from a ring surrounding the shaft.

4. The electric motor according to claim 2, wherein the flange has a plurality of radially outwardly projecting protrusions between which the recesses are located.

5. The electric motor according to claim 2, wherein the flange is screwed to the carrier.

6. The electric motor according to claim 2, wherein the clamping segments are located in radially extending grooves of a housing part.

7. The electric motor according to claim 1, wherein the floating bearing is arranged at the first end of the shaft and bears against an annular shoulder of the shaft on its side facing the fixed bearing, the fixed bearing bearing against a further annular shoulder of the shaft on its side facing the second end of the shaft.

8. The electric motor according to claim 1, wherein the housing has a first housing part forming a closed base and a second housing part from which the shaft projects, the first housing part having an inner part which projects into the stator and surrounds both the fixed bearing and the floating bearing in the stator.

9. The electric motor according to claim 8, wherein the ring is screwed to the first housing part.

10. The electric motor according to claim 8, wherein the first housing part forms the stop against which the fixed bearing is pressed.

11. The electric motor according to claim 1, wherein the shaft thickens between the floating bearing and the fixed bearing.
